(19) United States
(12) Patent Application Publication
(10) Pub. No.: US 2023/0234318 A1
(43) Pub. Date: Jul. 27, 2023

(54) Device and Method for Forming Paper Strapping

(71) Applicant: Encore Packaging LLC, Vernon Hills, IL (US)

(72) Inventor: Timothy H. NELSON, Winnetka, IL (US)

(21) Appl. No.: 18/159,925

(22) Filed: Jan. 26, 2023

Related U.S. Application Data
(60) Provisional application No. 63/303,255, filed on Jan. 26, 2022.

(51) Int. Cl. B31D 1/00

(52) U.S. Cl. CPC B31D 1/0056

(57) ABSTRACT

A device includes a housing having an entry opening for receiving a length of material, an applicator for applying a liquid to the length of material, a plurality of forming rollers for folding the length of material into a strap-like form, and a motor for driving at least one of the forming rollers. In one aspect, the plurality of forming rollers includes at least one primary forming roller for inducing at least one fold in a portion of the material, at least one secondary forming roller, and at least one tertiary forming roller for compressing the folded material against itself into a strap-like form for use in packaging applications.

### CROSS-REFERENCE TO RELATED APPLICATIONS

This application claims the benefit of Provisional Application No. 63/303,255, filed Jan. 26, 2022, which is incorporated herein by reference in its entirety.

### TECHNICAL FIELD

The present disclosure relates generally to devices and methods for packaging applications and, more specifically, to a device and method for forming paper strapping.

### BACKGROUND

Plastic strapping is commonly used in packaging applications to secure boxes or other forms of packages during transit or delivery. Such plastic strapping has typically been made out of polypropylene or polyester due to its tensile strength. The use of traditional plastic strapping, however, has certain drawbacks and disadvantages. For one, plastic strapping can be difficult to handle and can be costly. In addition, plastic strapping is not widely recyclable and thus can have negative effects on the environment.

Recently, strapping made from paper has been employed as a sustainable, eco-friendly alternative to conventional plastic strapping. Such paper strapping is desirable as it is plastic-free, fully recyclable, easier to work with, and cheaper. However, paper strapping having the requisite strength for packaging applications is not readily available.

Paper tape, such as Kraft paper tape or “gummed” paper tape, is also known for use in packaging applications for closing and sealing boxes. Such paper tape typically includes a water-activated adhesive that may be wet by a user and applied to a package to form a strong bond therewith. The water-activated adhesive may be starch-based and becomes sticky only when moistened. Paper tape is made of paper, so it is natural, recyclable, and compostable.

### BRIEF DESCRIPTION OF THE DRAWINGS

FIG. 1 is a left side perspective view of an example device for forming paper strapping showing a housing having an exit opening;

FIG. 2 is a left side perspective view similar to FIG. 1 with portions of the housing removed to show internal components of the device including a motor, a water reservoir, primary forming rollers, secondary forming rollers, and tertiary forming rollers;

FIG. 3 is a front perspective view of the device as shown in FIG. 2 showing the entry opening of the housing;

FIG. 4 is a top plan view of the device as shown in FIG. 2;

FIG. 5 is a left side elevation view of the device as shown in FIG. 2;

FIG. 6 is a perspective view of an example first primary forming roller of the device;

FIG. 7 is a perspective view of an example second primary forming roller of the device;

FIG. 8 is a diagram illustrating a mock-up of the first and second primary forming rollers as positioned in the device for folding at least a portion of a length of material;

FIG. 9 is a perspective view of an example roll of gummed paper tape;

FIG. 10 shows a length of example paper strapping formed by folding gummed paper tape; and

FIG. 11 is a schematic view of an example device for forming paper strapping.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present disclosure. Also, common but well-understood elements that are useful or necessary in a commercially feasible embodiment are often not depicted in order to facilitate a less obstructed view of the various embodiments. It will further be appreciated that certain actions and/or steps may be described or depicted in a particular order of occurrence while those skilled in the art will understand that such specificity with respect to sequence is not actually required.

### DETAILED DESCRIPTION

In accordance with one aspect of the present disclosure, a device is provided including a housing having an entry opening for receiving a length of material, an applicator for applying a liquid to the length of material, a plurality of forming rollers for folding the length of material into a strap-like form, and a motor for driving at least one of the forming rollers. In one aspect, the plurality of forming rollers includes at least one primary forming roller for inducing at least one fold in a portion of the material, at least one secondary forming roller, and at least one tertiary forming roller for compressing the folded material against itself into a strap-like form. The length of material may in some forms be a gummed paper tape, such as Kraft paper tape, which includes a water-activated adhesive such that the liquid applied thereto by the applicator may activate the adhesive and encourage the paper tape to stick to itself upon advancing through the plurality of forming rollers. So configured, the paper tape may be advanced into an entry opening of the device, water or other liquid may be applied to activate an adhesive of the paper tape, at least one of the plurality of forming rollers may induce one or more folds in the material, and at least one of the plurality of forming rollers may compress the folds of the wetted material against itself so as to adhere the folds to one another and form a paper strap for use in various packaging applications.

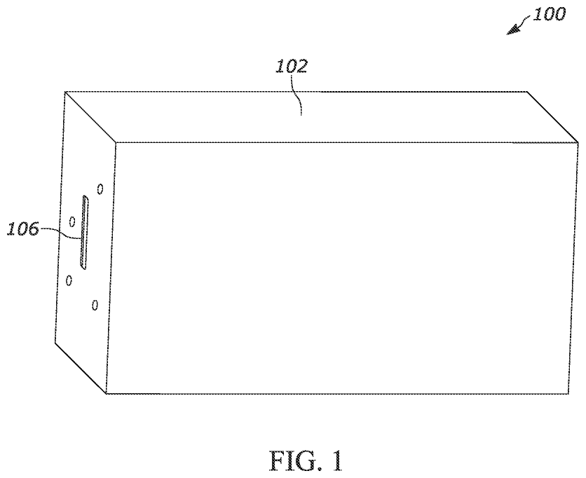

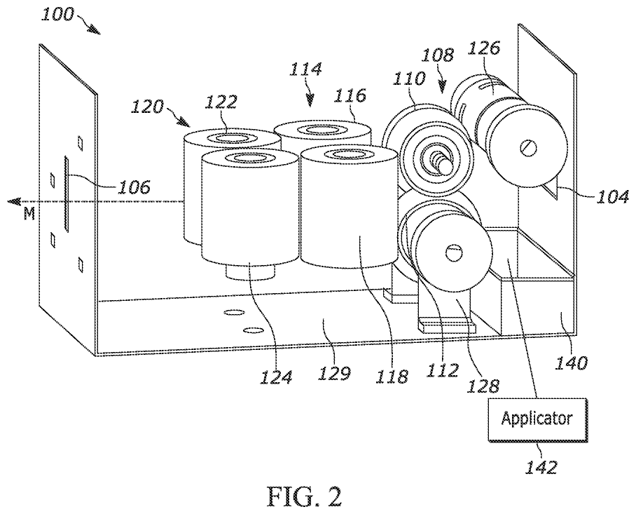

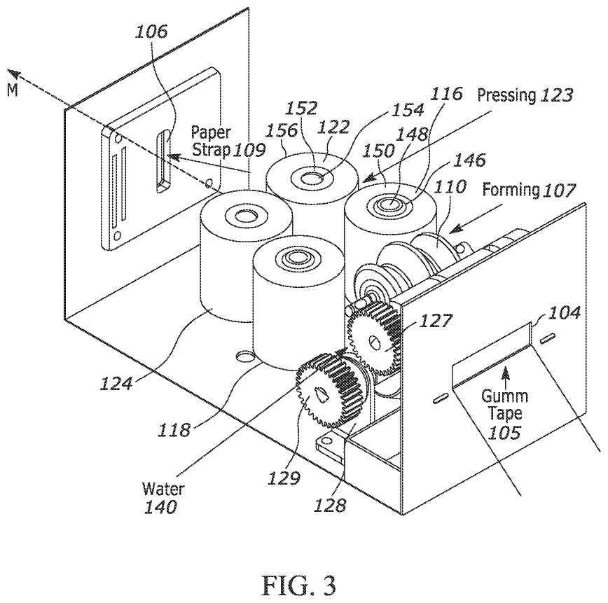

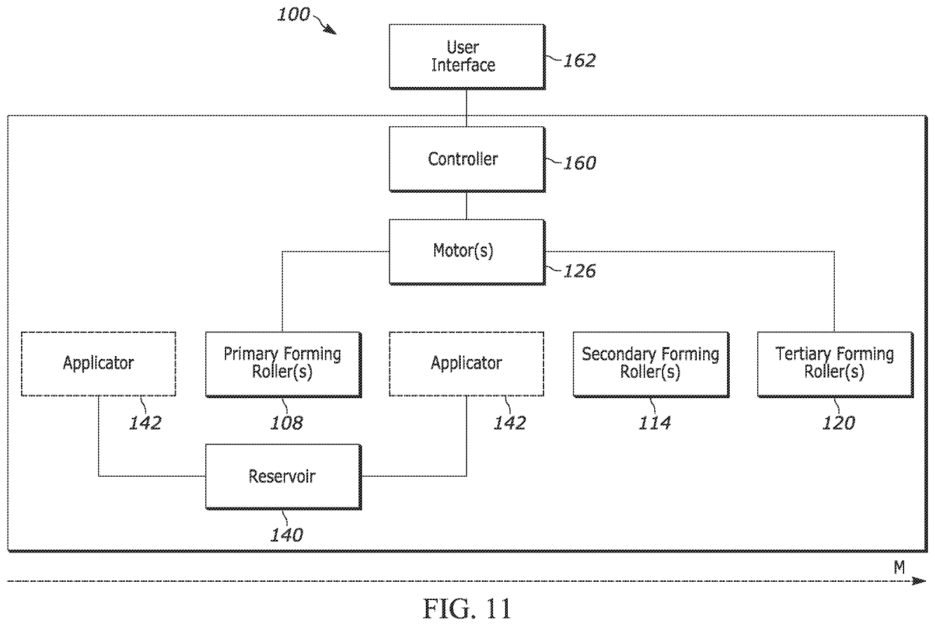

Referring now to the drawings, and more particularly FIG. 1, a device 100 is provided having a housing 102, an entry opening 104 (shown in FIGS. 2 and 3) for receiving a length of material such as gummed paper tape, and an exit opening 106 where paper strapping formed by the material exits the device 100. In some forms, a user interface may be positioned on or adjacent to the housing 102 for controlling various aspects of the device as schematically shown in FIG. 11. In some embodiments, the housing 102 may be formed of a metal material.

In FIG. 2, an upper portion of the housing 102 has been removed to illustrate various components of the device 100 involved in the process of folding the length of material received through the entry opening 104 into paper strapping. As illustrated, the device 100 includes forming rollers such as primary forming rollers 108 including a first primary roller 110 and a second primary roller 112, secondary forming rollers 114 including a first secondary roller 116 and a second secondary roller 118, and tertiary forming rollers 120 including a first tertiary roller 122 and a second tertiary roller 124. In some embodiments, the primary, secondary, and tertiary forming rollers 108, 114, 120 may include additional rollers or may only include a single roller. In still other embodiments, the device 100 may include fewer than all or any combination of the primary, secondary, and tertiary forming rollers (e.g., only primary and tertiary forming rollers), or may include additional sets of forming rollers. The “primary,” “secondary,” and “tertiary” naming convention is merely for convenience and ease of discussion and should not be understood to impart any specific ordering or structure.

The device 100 also includes at least one motor for driving at least one of the forming rollers to encourage the length of material 105 fed, such as for example gumm tape, into the entry opening 104 towards the exit opening 106. For example, motor 126 is provided that may be coupled to any or all of the primary, secondary, or tertiary forming rollers 108, 114, 120 for feeding the length of material through the device 100. The motor 126 may be mounted to an internal portion of the housing 102. In some forms, the motor 126 may be a stepper motor or a brushed or brushless motor. Although not illustrated, it should be understood that the motor 126 may be coupled to forming rollers in various different ways. As one example, the motor 126 may be coupled to either of the primary forming rollers 108 via a belt mechanism (e.g., a belt positioned over drive gear 127 and driven gear 129 in FIG. 3) to cause rotation thereof to assist in feeding material in the machine direction M. Additionally or alternatively, the motor 126 may be coupled to the secondary or tertiary forming rollers 114, 120 to cause rotation thereof to facilitate the advancement of the material through the device 100. In other embodiments, one or more additional motors may be included for separately driving the different sets of forming rollers included in the device 100.

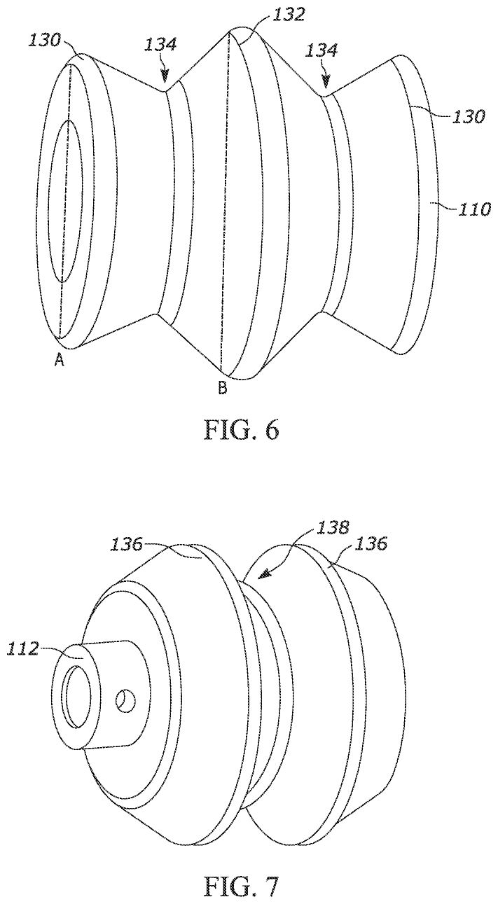

As illustrated, the first and second primary rollers 110, 112 are positioned proximate the entry opening 104, with the first primary roller 110 positioned directly above the second primary roller 112 and may be used for forming 107 the material 105 fed into the entry opening 104. The first and second primary rollers 110, 112 may be offset in other configurations. The second primary roller 112 is shown rotatably coupled to a strut 128 attached to a lower portion 129 of the housing 102 such that the second primary roller 112 may rotate about its central axis. The first primary roller 110 may be similarly coupled to the housing 102 (e.g., via a top portion or side portion(s) of the housing 102) via a strut (not illustrated) in a known manner to permit the first primary roller 110 to rotate. The first and second primary rollers 110, 112 are configured to induce one or more folds in the material once it is received through the entry opening 104. In particular, the first and second primary rollers 110, 112 may include one or more corresponding ridges extending radially outward from a center of each respective roller that are configured to impinge upon the length of material and cause the material to fold as it is advanced therebetween. The corresponding ridges of the first and second primary rollers 110, 112 are shown in further detail in FIGS. 6 and 7.

The first primary roller 110 of FIG. 2 is shown isolated in FIG. 6 and includes one or more ridges. The first primary roller 110 is illustrated having a pair of lateral ridges 130 at lateral ends of the roller 110 with a diameter A and a central ridge 132 between the lateral ridges 130 with a diameter B. The ridges 130, 132 extend radially outward from the surface of the first primary roller 110 and have corresponding valleys 134 situated therebetween that extend about the circumference of the first primary roller 110. In addition, the first primary roller 110 may include more or fewer ridges depending on the number of folds desired to be formed in the length of material.

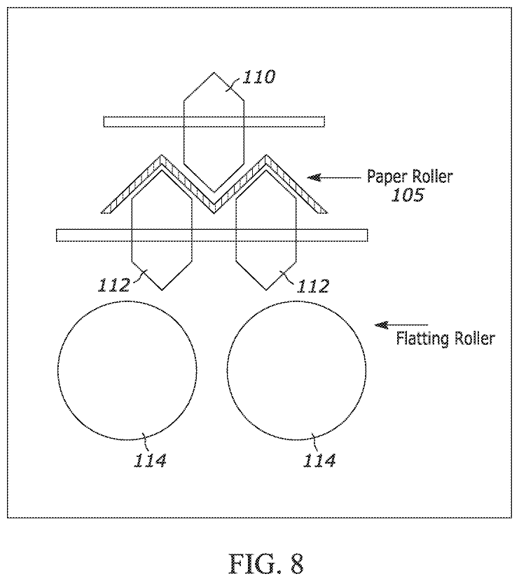

The second primary roller 112 of FIG. 2 is shown isolated in FIG. 7 and also includes one or more ridges. The second primary roller 112 is illustrated having a pair of ridges 136 extending radially outward from the surface of the roller 112 with a valley 138 positioned therebetween that is generally centrally located on the second primary roller 112. In operation, the ridges and valleys of the first and second primary rollers 110, 112 are contoured and shaped to correspond with one another so as to impart a folded shape to the length of material that is advanced therebetween. In particular, the central ridge 132 of the first primary roller 110 is sized and shaped to correspond with and be situated at least partially within the valley 138 of the second primary roller 112 (i.e., at least partially between the sidewalls of the ridges 136), and the ridges 136 of the second primary roller 112 are each sized and shaped to correspond with and be situated at least partially within the respective valleys 134 of the first primary roller 110 (i.e., at least partially between the sidewalls of the lateral ridges 130 and central ridge 132). As a result, a gap between the first and second primary rollers 110, 112 is defined having an “M”-like shape for receiving the length of material. So configured, material 105 moving between the gap defined by first and second primary rollers 110, 112 is induced into a generally “M”-like shape as it advances towards the secondary forming rollers 114 as roughly shown in the mock-up diagram of FIG. 8. If desired to induce more or fewer folds in the material, primary forming rollers having either more or fewer corresponding ridges may be employed.

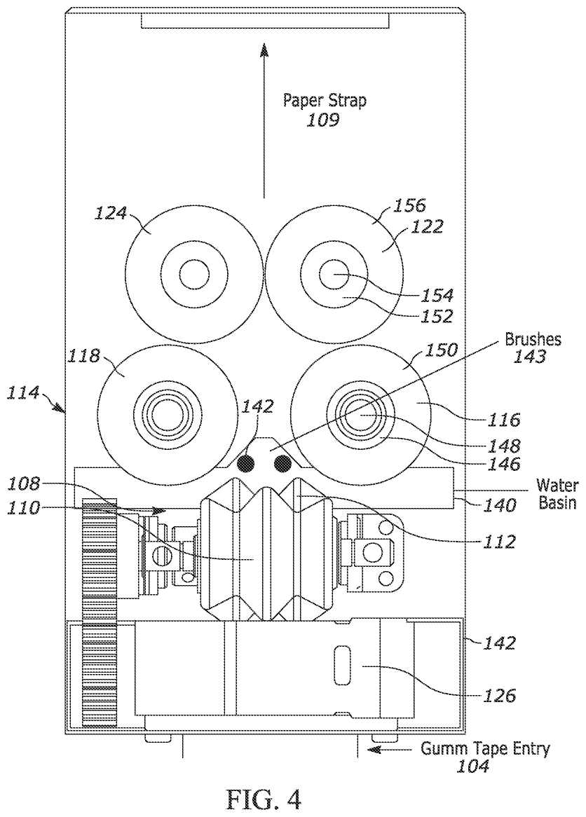

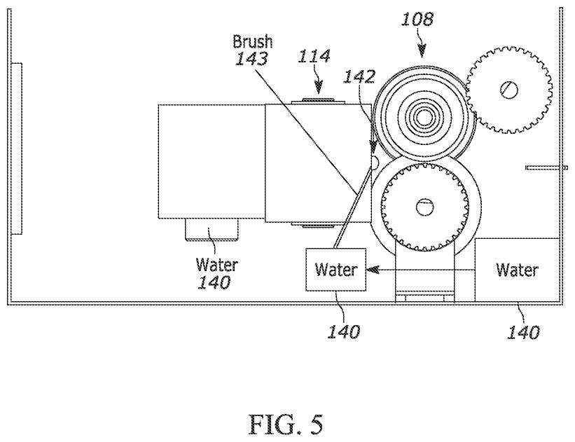

Referring to FIGS. 2-5, a reservoir 140 is located in the housing 102 that is configured to hold a liquid, such as water, for use in activating an adhesive on the material being advanced through the device 100. In some forms, the reservoir 140 may be refillable by a user through an aperture or opening (not shown) located on the side or another portion of the housing 102 or may be directly coupled to a water line. The reservoir 140 is coupled to an applicator 142 that is configured to deliver the liquid to the adhesive on the material such that the adhesive may be activated. In some forms, the applicator 142 may be in the form of a brush 143 (located as generally shown in FIGS. 4 and 5) that extends upwards for wetting the adhesive surface of the material as it advances between the primary and secondary forming rollers 108, 114. In other forms, the applicator 142 in the form of a brush 143 may be upstream of the primary forming rollers 108 (e.g., as shown in FIG. 2) and extend upwards between the entry opening 104 and the primary forming rollers 108 such that the material is wet before being partially folded by the primary forming rollers 108. Depending on the desired placement of the applicator 142, the reservoir 140 may be located in different portions of the housing 102 as shown in, e.g., FIGS. 3-5, between the strut 128 and the driven gear 129 in FIG. 3, and subsequently after the secondary forming rollers 114 in FIG. 5.

Referring again to FIGS. 2-4, once the material has been formed into the “M”-like, partially folded shape by the primary forming rollers 108, and the material is wet by the applicator 142 to activate the adhesive, the length of material is advanced towards the secondary forming rollers 114 such that the material moves between the first and second secondary rollers 116, 118. As illustrated, the first and second secondary rollers 116, 118 are spaced from one another and each include a cylindrical core 146 having a bore 148 extending therethrough and a covering or coating 150 extending around the core 146. Although not illustrated, the first and second secondary rollers 116, 118 may be rotatably mounted on a rod (not shown) by positioning the rod in the bore 148 such that the first and second secondary rollers 116, 118 may rotate freely about an axis defined by the rod. In alternative forms, the first and second secondary rollers 116, 118 may be driven by a motor, such as motor 126. The covering 150 may be formed of a rubberized or other pliable material that may facilitate gripping of the material being advanced between the first and second secondary rollers 116, 118. Upon the material advancing between the first and second secondary rollers 116, 118, the covering 150 may impinge on and cause the lateral edges of the partially folded material to move slightly inwards towards a center of the material so as to at least partially compress the folds thereof.

The length material with activated adhesive is next advanced through the tertiary forming rollers 120 for further compression, i.e., pressing 123, of the material into a strap-like form. Similar to the secondary forming rollers 114, the first and second tertiary rollers 122, 124 each include a cylindrical core 152 having a bore 154 extending therethrough and a rubberized or pliable covering or coating 156 extending around the core 152. In the illustrated form, the first and second tertiary rollers 122, 124 are positioned such that the coverings 156 of each respective roller are at least partially abutting one another as shown in FIG. 4. Upon the material advancing towards the first and second tertiary rollers 122, 124, the already partially compressed folds of the length of material are drawn between the coverings 156, and the lateral edges of the material and accordion-like folds therebetween are further compressed towards one another. Due to the closely engaged nature of the coverings 156 of each respective roller 122, 124 and the pressure applied thereby, the folds of the material are firmly compressed against one another as the material is advanced and the activated adhesive on the material functions to adhere the folds of the material to one another to retain the material in a strap-like form. Once compressed in this manner, the strap 109 moves downstream of the tertiary forming rollers 120 and exits the device 100 through the exit opening 106 where it may be cut at a desired length and used as paper strapping for packaging applications.

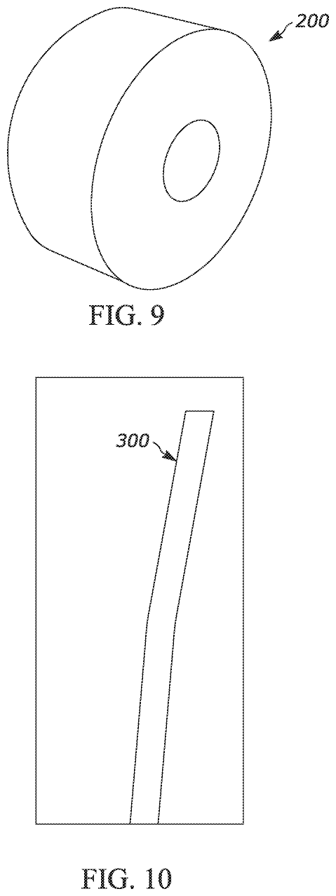

Referring now to FIG. 9, an example roll of paper tape 200 having a water-activated adhesive is shown, which may sometimes be referred to as gummed paper tape or gummed tape, that may be used in connection with the device 100 to form paper strapping. In particular, the paper tape may in some instances include internal threads formed of a filament such as string or fiberglass between thin layers of paper stock to improve the tensile strength of the tape. As explained above, the paper tape typically includes a water-activated adhesive which may be starch or latex based such that the adhesive becomes sticky when moistened. Surprisingly, when the paper tape 200 is wetted and folded upon itself so as to form a thin paper strap of material, the paper strap exhibits a very high tensile strength that is useful in packaging applications. In FIG. 10, a paper strap 300 formed from folding and adhering paper tape in this manner is shown as an example. As such, the paper tape 200 may be beneficially utilized in connection with the device 100 by feeding such paper tape into the device 100 to create resilient paper strapping in the manner described above that has improved qualities over currently available plastic strapping solutions. For example, the paper strapping can be clipped and secured using clips and tools much like or even the same as those used for securing shipped articles with plastic strapping.

Referring now to FIG. 11, a schematic diagram of the device 100 is shown that generally illustrates the flow of material moving through the device 100 left to right in the machine direction M as explained above. In particular, material such as paper tape may be fed into the entry opening of the device 100, water may be applied to the paper tape by the applicator 142 before (or after) the tape is partially folded by the primary forming rollers 108, and the tape may continue to advance through the secondary and tertiary forming rollers 114, 120 to further compress and form the paper strapping contemplated herein before exiting the device. In order to control operation of the motor 126, or any other motors that may be coupled to any or all of the forming rollers, a controller 160 may be included. The controller 160 may be, for example, a known processor or printed circuit board (PCB) for controlling various aspects of the device 100. In particular, the user interface 162 which may be a touch screen, switch, or other suitable interface for operating the device 100 that is operatively coupled to the controller 160 such that the user may control the feeding of material through the device 100 via operation of the motor 126. In order to operate the device 100, the device 100 may be coupled to a power source in a known manner.

While there have been illustrated and described particular embodiments, it will be appreciated that numerous changes and modifications will occur to those skilled in the art, and it is intended for the present disclosure to cover all those changes and modifications which fall within the scope of the appended claims. For example, it should be understood that the example devices provided herein for forming paper strapping using paper tape may be used as a “point of use” solution to permit users to feed paper tape into the device and form paper strapping on an as-needed basis or may alternatively be used “in-line” to form paper strapping during the process employed to form the paper tape. So configured, the example devices may be used for forming paper strapping using paper tape both in and off of a paper tape production line.

What is claimed is:

1. A device for forming paper strapping, the device comprising:
a motor;
a primary forming roller having one or more radially extending ridges, the primary forming roller configured to at least partially fold a length of material, the primary forming roller operatively coupled to the motor;
an applicator proximate the primary forming roller, the applicator configured to apply liquid to the length of material;
a secondary forming roller downstream of the primary forming roller; and
a tertiary forming roller downstream of the secondary forming roller.

2. The device of claim 1, wherein the applicator is positioned downstream of the primary forming roller.

3. The device of claim 1, wherein the applicator is a brush coupled to a reservoir containing the liquid.

4. The device of claim 1, further comprising a user interface configured to receive a user input for controlling operation of the motor.

5. The device of claim 1, further comprising a second primary forming roller positioned proximate the primary forming roller, the second primary forming roller having one or more radially extending ridges.

6. The device of claim 1, further comprising a housing enclosing one or more of the primary, secondary, and tertiary forming rollers.

7. A method of using the device of claim 1 to form paper strapping, the method comprising:
feeding a length of paper tape towards the primary forming roller; and
operating the motor to drive the primary forming roller.
